(19) United States
(12) Patent Application Publication
(10) Pub. No.: US 2011/0094201 A1
(43) Pub. Date: Apr. 28, 2011

(54) Center Draper Belt With Crop Conveying Features

(76) Inventors: Duane Bomleny, Geneseo, IL (US); Terry Demay, Annawan, IL (US); William Payne Conrad, Bettendorf, IA (US); Todd Neil Signer, East Moline, IL (US)

(21) Appl. No.: 12/606,404

(22) Filed: Oct. 27, 2009

(51) Int. Cl. A01D 43/00

(52) U.S. Cl. 56/181

(57) ABSTRACT

A center draper belt for a center conveyor of a draper platform that is configured to carry a crop mat of severed plant stalks in a first direction, the crop mat having a maximum operating thickness, the belt comprises a generally planar web having first and second longitudinally side edges disposed on opposite sides of the web; and first and second ridges fixed to the longitudinal side edges and extending upward therefrom to stop plant stalks of a bottom layer of the crop mat from being propelled off the side edges.

### FIELD OF THE INVENTION

The invention relates to agricultural harvesters. More particularly, it relates to draper platforms for agricultural harvesters. Even more particularly, it relates to the construction of center draper belts for draper platforms.

### BACKGROUND OF THE INVENTION

Draper platforms are harvesting heads supported on the front of self-propelled agricultural combine vehicles (hereinafter “combine”). They are configured to cut the stalks of crop plants, severing them from the ground, to direct the crop plant onto endless belt side conveyors to form a thick crop mat. The side conveyors convey their respective crop mats laterally from either side of the center conveyor toward a center conveyor. The center conveyor, in turn, receives the crop mats, combines them and redirects their flow ninety degrees from a lateral direction of travel to a rearward direction. The center conveyor carries the now-combined crop mats rearward toward an aperture in the draper platform frame. Once the cut crop matter passes through the aperture in the frame, it is received in a feederhouse which is supported on the front of the combine and which supports the draper platform.

In recent years, manufacturers have designed wider draper platforms to harvest a wider swath of crop with each pass of the combine through the field. Each incremental width of the draper platform proportionately increases the farmer's productivity.

Manufacturers have made these draper platforms wider by increasing the length of the side conveyors such that they receive cut crop material from a wider swath of crop in the fields. As a result, the side conveyors carry a proportionally larger amount of cut crop material and the crop mats are thicker. The side conveyors run faster as well.

Unfortunately, the width of the center conveyor cannot be substantially increased to carry this increased volume of cut crop. The width of the center conveyor is limited by the width of the combine feederhouse. As a result the side conveyors deposit a cut crop mat on the center conveyor that can be as much as 1.5 to 2 feet thick.

Usually, when the crop being harvested is of equal thickness on both sides of the draper platform, the crop mats conveyed by the left and right side conveyors collide in the middle of the center conveyor, are stopped, and are turned rearward by the center conveyor.

Under certain conditions, however, such as when one side of the draper platform is receiving much more crop than the other, or when the draper platform is harvesting crop on a steep hillside, crop is delivered more effectively by one side conveyor of the machine than by the other. A side-to-side imbalance in the volume of crop flow (e.g. the left side conveyor having a crop mat of much greater thickness than the right side conveyor or vice versa) causes the two crop mats to no longer collide in the center of the draper platform. Instead, the thicker crop mat (the dominant mat) will push the smaller, lighter crop mat delivered from the other side conveyor out of the way, and will travel across the entire width of the center conveyor without being stopped and turned 90° rearward. This causes the bottom layer of the crop mat on the dominant side to be injected into the gap between the side conveyor on the opposite side of the center conveyor and the center conveyor itself.

The returning belt portion of the side conveyor grabs the long plant stalks comprising the bottom layer of the crop mat and proceeds to pull the bottom layer of the crop mat off the center conveyor and into a gap between the top of the center conveyor belt and the bottom of the returning belt portion of the side conveyor.

Given the elongated string-like structure, the rough exterior, and the intertwined nature of the plant stalks in the crop mats, once a few stalks from the bottom layer are pulled into the gap, they in turn pull the stalks on top of them into the gap. In this manner, a substantial portion of a crop mat of plant stalks that is 10 or 30 cm high may be drawn into a gap that is only one-fifth as thick as the crop mat. The plant stalks dragged into this gap fall on the ground and are lost. This problem is called “underfeeding”.

The problem to be solved is that of underfeeding the bottom layer of a crop mat composed of interengaging plant stalks into a gap between a center conveyor and an overlying and spaced apart upper conveyor.

The problem of eliminating underfeeding must be distinguished from the problem of containing loose and fluent material on a conveyor belt. Conveyors exist for granular, powdered, or other fluent materials. These conveyors are used in the pharmaceutical industry, chemical processing industry, power plants, rock quarries and other places where fluent materials are conveyed a significant distance via conveyor belts. These conveyors face the problem of containing the material as it is jostled, spreads and settles. They are often in the form of a conveyor belt that is forced into a “V”-shape, or a flat conveyor belt with raised walls along its outer edges.

The arrangement described herein can be distinguished from fluent material conveyors in the nature of the material carried, the problem that is solved, and the differences in the length of the conveyor and its width, as well as the height of the conveyor walls. First, fluent material must be contained or it will settle and spread until it pours off the edge of the conveyor belt. This is not the problem solved by the present invention. A cut crop mat does not spread or settle across the 80-175 cm width center conveyor over its 75 to 150 cm long path. Second, fluent material must be contained by walls that extend upward higher than the maximum operating height of the material carried by the conveyor belt. In the present invention the thickness of the crop mat can be 30 to 50 cm thick, yet the ridges provided on the edges of the center conveyor belt described herein are perhaps only a tenth of the conveyed material height, e.g. 1.5 to 5 cm. Third, fluent material conveyors are provided with sidewalls to contain material that flows out under the force of gravity, not to provide a barrier between the conveyed material and an adjacent apparatus that will pull the conveyed material out of the center conveyor.

### SUMMARY OF THE INVENTION

What is needed, therefore, is an improved center conveyor belt for draper platform that better engages the bottom layer of the crop mat and more effectively turns it from its lateral flow direction to a rearward flow direction. It is also an object of this invention to provide belting for making an endless belt for a center conveyor that solves this problem. It is also an object of this invention to provide an improved endless belt and center conveyor using such an endless belt. It is also an object of this invention to provide an improved draper platform having such a center conveyor.

The function of the crop arresting structures for center draper belts in the present application is to halt the crop mat as it travels across the center conveyor at the conveyor loading location, to prevent only the material in the bottom layer of the crop mat from being pulled into a gap between the side conveyor and the center conveyor, and to prevent the intertwined fibers of the plant stalks in the bottom layer from pulling a stream of adjacent plant stalks out from the bottom of the crop mat deposited on center conveyor.

In accordance with a first aspect of the invention, a center draper belt for a center conveyor of a draper platform is provided that is configured to carry a crop mat of severed plant stalks in a first direction, the crop mat having a maximum operating thickness, the belt comprising a generally planar web having first and second longitudinally side edges disposed on opposite sides of the web; and first and second ridges fixed to the longitudinal side edges and extending upward therefrom to a height of between 10 and 40 mm to stop plant stalks of a bottom layer of crop mat from being propelled across the web and off the side edges by feeder conveyors that feed the center draper belt at right angles to the first direction.

The first and second ridges may extend substantially the entire length of first and second side edges and have a height just sufficient to substantially prevent underfeeding an adjacent side conveyor. The first and second ridges may form first and second serpentines, respectively. The serpentines may define recesses configured to receive plant stalks of the crop mat moving in a lateral direction across the width of the web. The first and second ridges may have a height sufficient to prevent plant stalks of the crop mat from being carried across the top of the web and into a gap between the top surface of the web and the endless belt of a side conveyor. The web may have a width to carry a layer of plant stalks that is at least twice as thick as the height of the crop stalk engaging structures. The web may have a width of at least 80 cm. The web may have a width of at least 120 cm. The web may have a width of at least 160 cm. The belt may be configured to carry a crop mat that is at least 30 cm deep. The belt may be configured to carry a crop mat that is at least 40 cm deep. The first and second ridges may be no more than 1.5 cm high. The first and second ridges may be no more than 4.0 cm high. The center draper belt may further comprise an array of third ridges fixed to a central portion of the crop-conveying surface of the web, wherein each of the third ridges extends generally longitudinally, defines a serpentine and has at least one recess opening laterally and disposed to receive and arrest plant stalks traveling laterally across the central portion in a first lateral direction. Each ridge of the array of third ridges may have at least one recess opening laterally and disposed to receive and arrest plant stalks traveling laterally across the central portion in a second lateral direction opposite the first lateral direction. The ratio of maximum crop mat thickness on the belt to maximum height of the first and second ridges may be at least 5. The ratio of maximum crop mat thickness on the belt to maximum height of the first and second ridges may be at least 10. The ratio of web width to travel path may be between 0.9 and 4.0.

In accordance to a second embodiment of the invention, a draper platform for an agricultural combine is provided, comprising an elongate frame, a reciprocating knife disposed along a leading edge of the frame, left and right conveyors disposed on the left and right sides of the frame, respectively and a center conveyor disposed on the frame between the left and right conveyors to receive a crop mat from the left and right conveyors and carry the combined crop mats from the left and right conveyors rearward toward the agricultural combine, the center conveyor comprising front and rear rollers and an endless center draper belt entrained about the front and rear rollers, wherein the center draper belt is configured to carry a crop mat of severed plant stalks in a first direction, the crop mat having a maximum operating thickness, the belt comprising a generally planar web having first and second longitudinally side edges disposed on opposite sides of the web; and first and second ridges fixed to the longitudinal side edges and extending upward therefrom to a height of between 10 and 40 mm to stop plant stalks of a bottom layer of crop mat from being propelled across the web and off the side edges by feeder conveyors that feed the center draper belt at right angles to the first direction.

### DETAILED DESCRIPTION OF THE DRAWINGS

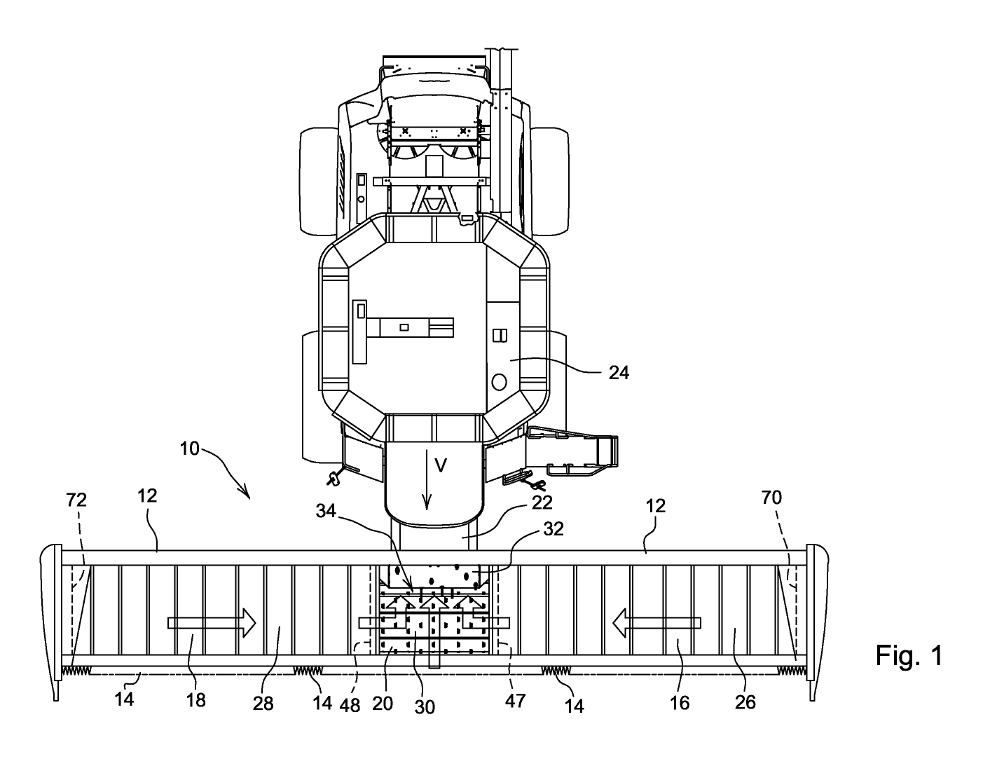

FIG. 1 is a plan view of a draper platform in accordance with the present invention.

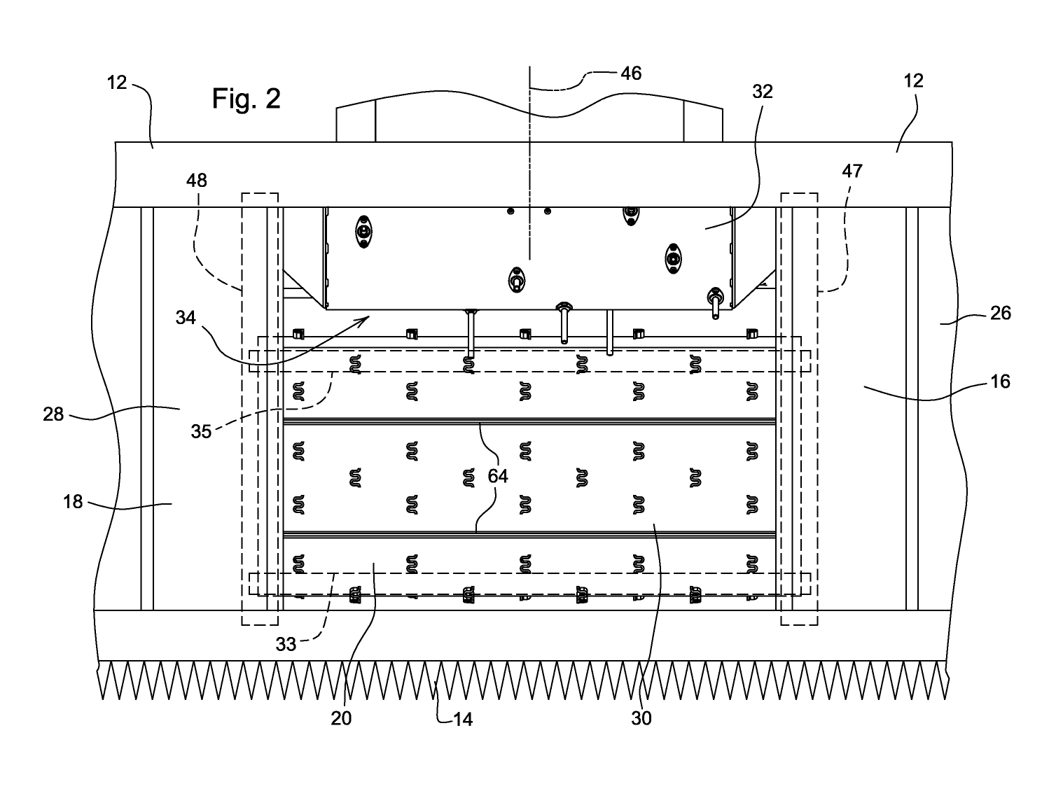

FIG. 2 is a fragmentary plan view of a central portion of the draper platform of FIG. 1 showing the relative location of the side conveyors and the center conveyor.

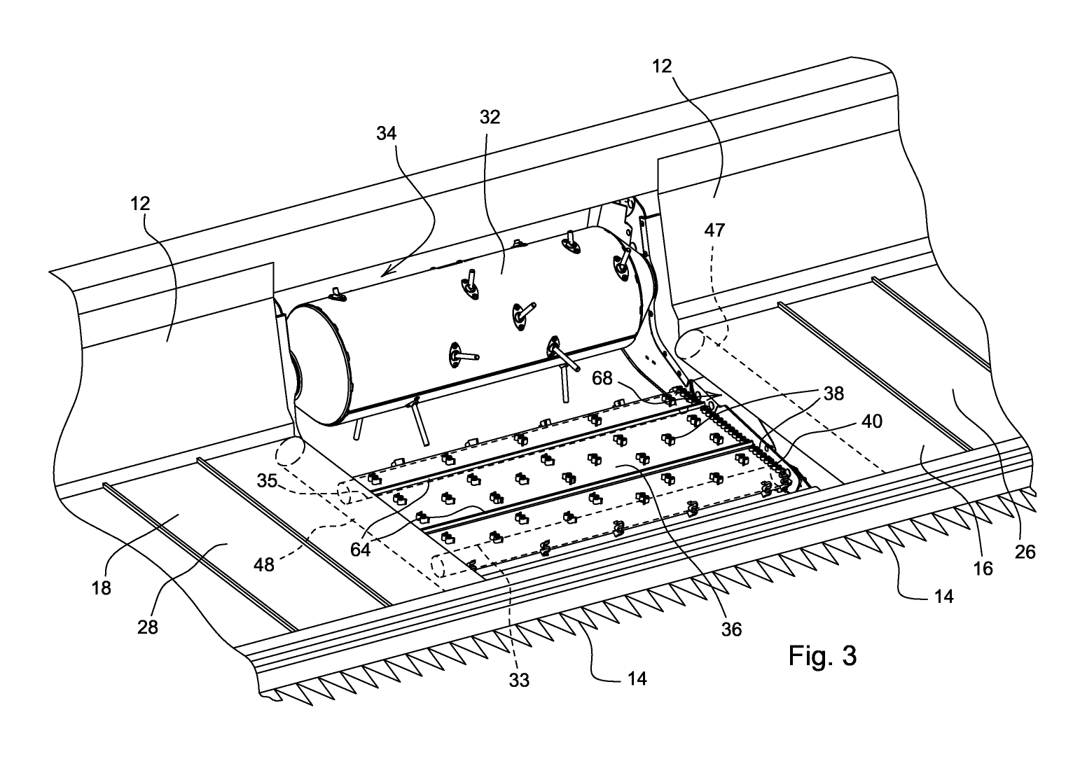

FIG. 3 is a fragmentary perspective view of a central portion of the draper platform showing the lower position of the center conveyor with respect to the two side conveyors.

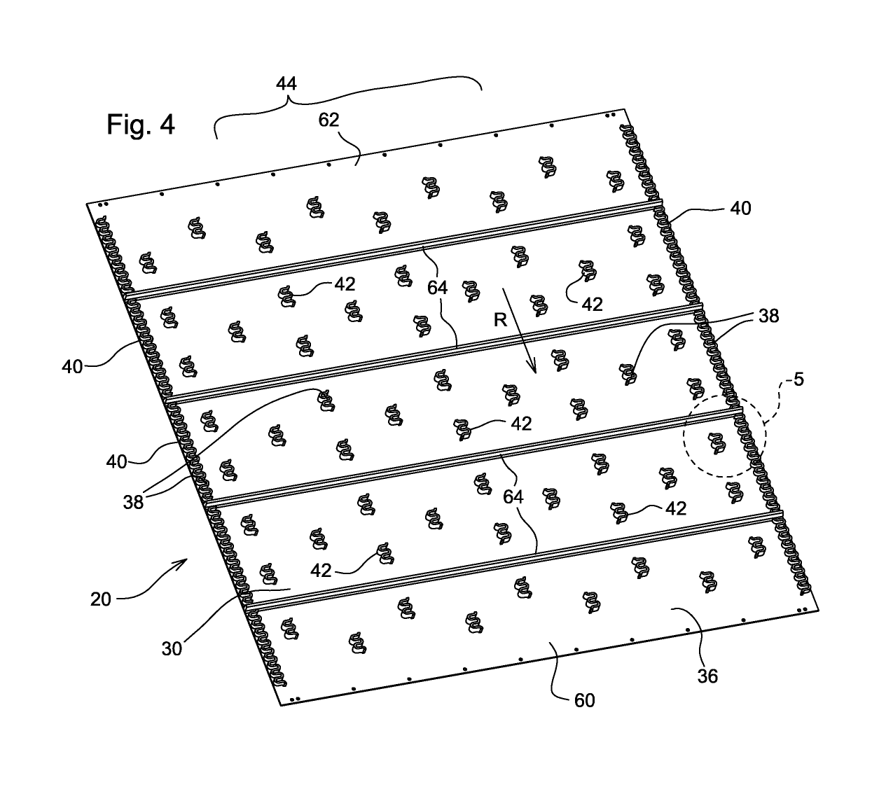

FIG. 4 is a perspective view of the endless belt of the center conveyor outstretched without the ends being spliced together.

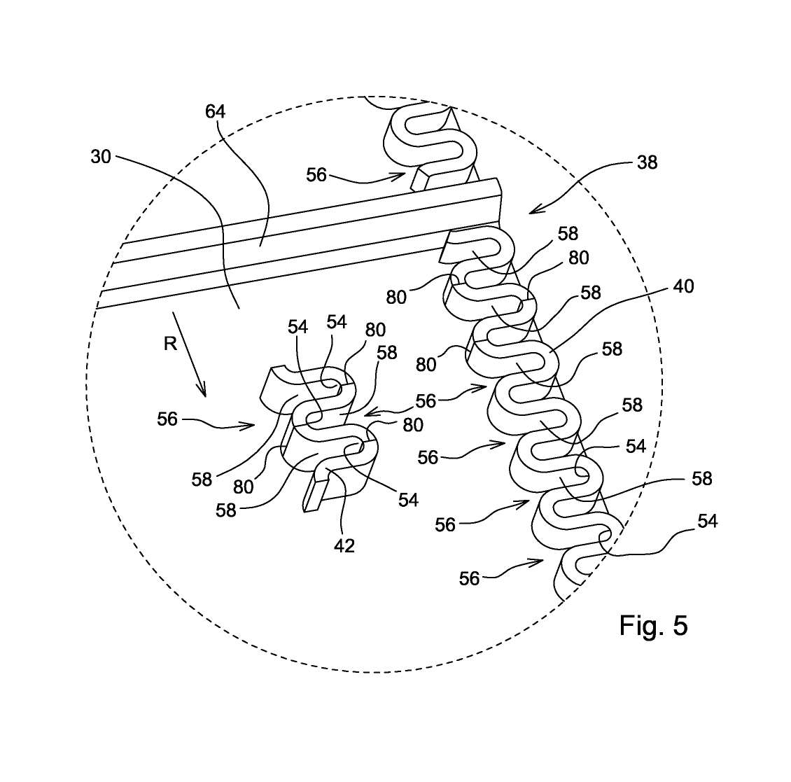

FIG. 5 is a detail view of Detail 5 in FIG. 4 showing typical structures 38 in more detail.

### DETAILED DESCRIPTION OF THE PREFERRED EMBODIMENTS

In FIGS. 1 and 2, a draper platform 10 is shown having a frame 12, a reciprocating knife 14 disposed along a leading edge of frame 12, two left side and right side conveyors 16, 18, and center conveyor 20. Draper platform 10 is supported on a feederhouse 22, which in turn is supported on the front of a combine 24.

In operation, combine 24 drives through an agricultural field in the direction of travel indicated by the arrow “V” in FIG. 1, conveying the draper platform in a direction generally perpendicular to its longitudinal extent. Reciprocating knife 14 located along the leading edge of draper platform 10 engages the plant stalks, severing them from the ground and causing them to fall rearward on to the left side conveyor 16, center conveyor 20, and right side conveyor 18. Each of the three conveyors 16, 18, 20 has an endless belt 26, 28, 30, respectively. Each of endless belts 26, 28, 30 provides a generally flat surface to support the crop and move in a direction indicated by the arrows superimposed on the conveyors (in FIG. 1). When the conveyor belts 26, 28 reach their innermost extent, they wrap around rollers 47, 48, respectively, and return to their respective outer ends of the draper platform, where their movement is again reversed around outer rollers 70, 72, respectively, and follow a return path back to the rollers 47, 48 (in the case of the side conveyors).

The left side conveyor 16 and the right side conveyor 18 steer the crop material ninety degrees to flow in a lateral direction generally perpendicular to the direction of travel “V” and toward the center conveyor 20. The cut crop material on the left side conveyor and the right side conveyor form thick mats that are directed into each other such that they collide above the surface of the endless belt 30 of the center conveyor 20. These mats are grabbed by structures extending above the surface of the endless belt 30 and are steered in a rear direction underneath feed roll 32 and through aperture 34 in frame 12. This cut crop material passes through feederhouse 22 and into combine 24 for processing. The ninety degree turn of the crop mats is illustrated by the ninety degree arrows shown in FIG. 1.

Referring to FIGS. 3 and 4, endless belt 30 of center conveyor 20 includes a generally flat web of belting 36 on which are mounted several crop arresting structures 38 that help steer and convey the cut crop material in a rearward direction toward feederhouse 22 and combine 24. The structures 38 include ridges 40 extending along both the left and right side edges of endless belt 30. In addition, they include an array of similar raised ridges 42 disposed in a central portion 44 of endless belt 30. The raised ridges 42 are disposed in a staggered pattern across the central portion 44.

The draper platform 10 is symmetric about the centerline 46 (FIG. 2) of the draper platform, and thus endless belt 26 of the left side conveyor 16 is similarly arranged with respect to endless belt 30 but in a mirror relation to that of endless belt 28.

The relative positions and interoperation described herein between endless belt 28 and endless belt 30 is the same as between endless belt 26 and endless belt 30, but in mirror relation about centerline 46. Endless belt 30 is supported on and is driven in recirculating movement around rollers 33 and 35.

Rollers 33 and 35 are typically spaced 30 to 70 cm apart. The web 36 of endless belt 30 has an overall width of 50 to 80 cm. Endless belt 30 therefore has a smaller roller to roller working travel length (30-70 cm) than its width (50-80 cm), which indicates how dissimilar the current arrangement is from typical bucket conveyor belts having high sidewalls to contain fluent material over great distances.

Note that endless belt 28 is generally disposed above endless belt 30, such that the crop mat carried on endless belt 28 falls downward onto the top surface of endless belt 30. Similarly, endless belt 26 is generally disposed above endless belt 30 and the crop mat carried on endless belt 26 falls downward onto the top surface of endless belt 30 in a similar manner.

Web 36 is preferably a flat and generally planar sheet of elastomeric covered or impregnated fabric. A series of four cleats 64 are fixed at intervals on the outer working surface of web 36. These four cleats extend transversely to the rearward direction of travel of endless belt 30 and extend across substantially the entire width of the endless belt 30. Each cleat is preferably as long as the web 36 is wide. This arrangement of a planar sheet to which transversely extending cleats 64 are fixed is one traditional arrangement of draper belts.

Note that due to their transverse orientation, cleats 64 do not resist the side-to-side travel of the crop mats from endless belts 26, 28 as the crop mats are thrown onto endless belt 30 from side conveyors 16, 18. The inability to prevent the bottom layers of the crop mats from being inserted into the gaps between the side conveyors in the center conveyor gives rise to the invention described herein.

When a thick crop mat falls off endless belt 28 it is projected by belt 28 (in the opposite direction as the crop on belt 26) across the surface of endless belt 30. It can, if it is not interrupted in its travel by collision with an opposing mat arriving from belt 26, have its bottom layer pulled into the narrow gap 68 (see FIG. 3) between the top of endless belt 30 in the bottom of endless belt 26.

Similarly, when a thick crop mat is thrown off endless belt 26 it is projected by belt 26 across the width of endless belt 30. It can, if it is not interrupted in its travel by collision with an opposing mat arriving from belt 28, have its bottom layer pulled into the narrow gap between the top of endless belt 30 and the bottom of endless belt 28.

The vertical gap between the bottom of endless belts 26, 28 and the top of endless belt 30 measured at the left and right edges of endless belt 30 preferably varies between 5 mm of vertical clearance and 65 mm of vertical clearance depending on the angle of the center conveyor 20 with respect to the side conveyors 16, 18 and the amount the center conveyor is permitted to flex up and down.

Crop arresting structures 38, which comprise ridges 40 and 42, prevent the crop mats from being pulled into these narrow gaps.

Referring now to FIG. 5, there are at least two ways in which plant stalks in the crop mat are arrested by ridges 40. First, the raised edges have inner walls 54 that extend upward from web 36 at an angle sufficient to arrest the lateral motion of the plant stalks when the plant stalks hit these inner walls. Second, ridges 40 are preferably formed as a serpentine. The serpentine construction creates recesses or pockets 56 that receive the plant stalks.

Each of these recesses 56 has an inner sidewall 54 that arrests the forward motion of the plant stalks (described above), but also has sidewalls 58 that face in the direction of travel of the center conveyor, abut the plant stalks, and push them forward in the direction of travel of the endless belt 30. Ridges 40 in the form of a straight, non-serpentine strip extending parallel to the edge of the web would be sufficient to arrest the lateral motion of the plant stalks across the width of endless belt 30. By forming the ridges 40 in a serpentine pattern, the recesses increase the ability of endless belt 30 to pull the crop mat in the direction of travel of the center belt and steer it 90° to flow in a rearward direction opposite the direction of travel of the combine.

The height of ridges 40 is purposely kept low so it only interrupts the travel of the bottom layer of plant stalks of each crop mat. If ridges 40 are higher than the top surface of endless belt 26, or higher than the top surface of endless belt 28, the ridges will prevent the crop mat from falling off endless belt 26 or endless belt 28, respectively. The ratio of the maximum operating thickness of the crop mat on web 36 to the maximum height of ridges 40 above web 36 is preferably at least 5. More preferably it is at least 10. Even more preferably it is at least 15. This low ridge height as compared to the height of the crop mat permits only the bottom layers of the crop mat to be prevented from passing into the vertical gap between endless belt 30 and endless belts 26, 28.

On the other hand, if ridges 40 are so short they do not arrest the forward motion of the bottom layer of plant stalks, they will permit the bottom layer of the crop mat to travel into the narrow gap between belt 26 and 30 and between belt 28 and 30. Center conveyor 20 is immediately adjacent to, and slightly below the side conveyors 16, 18. Center conveyor 20 cannot be lowered or the side conveyors raised to increase the vertical gap since side conveyors 16, 18 must be immediately adjacent to the ground and directly behind reciprocating knife 14 to [pick up the severed plant stalks, and the center conveyor 20 must be located slightly below the side conveyors to receive the crop from the side conveyors.

For these reasons, the height of ridges 40 falls within a narrow band and are substantially shorter than the maximum operating thickness of the crop mat carried on endless belt 30. Ridges 40 extend upward from web 36 to a height of 10 to 40 mm, more preferably to a height of 12 to 35 mm, and even more preferably to a height of 15 to 30 mm.

The action of the ridges 40 are further enhanced by ridges 42. Ridges 42 are fixed on the surface of endless belt 30, extend in a longitudinal direction, and have a greater extent in a direction parallel to the rearward direction of travel of the endless belt 30. Ridges 42 have a generally vertical surface on both sides, one surface facing the crop mat arriving from endless belt 26 and the other opposing surface facing the crop mat arriving from endless belt 28. These generally vertical crop-facing surfaces act as barriers against which the plant stalks of the crop mats from both side conveyors 16, 18 can butt against to stop their lateral motion across the top surface of endless belt 30.

Ridges 42 preferably describe a serpentine pattern that defines recesses 56 with sidewalls 58 on both sides of the ridges 42 to assist in stopping lateral movement of the plant stalks, but to grab the ends of the plant stalks inserted into these recesses and help steer them 90° into the rearward direction of travel of center conveyor 20. Recesses 56 extend transversely into ridges 40 and 42 in order to receive plant stalks traveling laterally across the surface of web 36.

Ridges 40, 42 have lower surfaces that are bonded to the surface of web 36. Sidewalls 54, 58 of ridges 40, 42 are preferably oriented at an angle of between 70° and 130° with respect to the surface of web 36. More preferably they are oriented at an angle of between 80° and 120° with respect to the surface of web 36. Even more preferably, they are oriented at an angle of between 90° and 110° with respect to the surface of web 36.

Ridges 40, 42 may be provided with slices (or notches) 80 that extend in a transverse direction generally perpendicular to the direction of travel of endless belt 30 and vertically, from the top of the ridges 40, 42 to web 36. The slices 80 are preferably located at the root or bottom of the recesses 56 thereby permitting the sides of the recesses 56 to spread apart when passing over roller 35 thereby releasing the grip the recess 56 has on the plant stalks and permitting them to be carried rearward into feederhouse 22 (FIG. 1).

The wall thickness of ridges 40, 42 varies from 2 mm to 10 mm. This is a substantial width as compared to the height of ridges 40, 42 and is intended to permit the ridges 40, 42 to withstand the wear of the plant stalks and to absorb their impact without damage. More preferably the wall thickness varies from 3 mm to 7 mm. Even more preferably it varies from 4 mm to 6 mm.

The web width to travel path ratio of center conveyor 30, is preferably between 0.9 and 4.0. More preferably the ratio is between 1.0 and 3.0. Even more preferably the ratio is between 1.2 and 2.5.

1. A center draper belt for a center conveyor of a draper platform that is configured to carry a crop mat of severed plant stalks in a first direction, the crop mat having a maximum operating thickness, the belt comprising:
a generally planar web having first and second longitudinally side edges disposed on opposite sides of the web; and
first and second ridges fixed to the longitudinal side edges and extending upward therefrom to a height of between 10 and 40 mm to stop plant stalks of a bottom layer of crop mat from being propelled across the web and off the side edges by feeder conveyors that feed the center draper belt at right angles to the first direction.

2. The center draper belt of claim 1, wherein the first and second ridges extend substantially the entire length of first and second side edges and have a height just sufficient to substantially prevent underfeeding an adjacent side conveyor.

3. The center draper belt of claim 1, wherein the first and second ridges form first and second serpentines, respectively.

4. The center draper belt of claim 3, wherein the serpentines define recesses configured to receive plant stalks of the crop mat moving in a lateral direction across the width of the web.

5. The center draper belt of claim 1, wherein the first and second ridges have a height sufficient to prevent plant stalks of the crop mat from being carried across the top of the web and into a gap between the top surface of the web and the endless belt of a side conveyor.

6. The center draper belt of claim 1, wherein the web has a width to carry a layer of plant stalks that is at least twice as thick as the height of the crop stalk engaging structures.

7. The center draper belt of claim 1, wherein the web has a width of at least 80 cm.

8. The center draper belt of claim 7, wherein the web has a width of at least 120 cm.

9. The center draper belt of claim 8, wherein the web has a width of at least 160 cm.

10. The center draper belt of claim 7, wherein the belt is configured to carry a crop mat that is at least 30 cm deep.

11. The center draper belt of claim 10, wherein the belt is configured to carry a crop mat that is at least 40 cm deep.

12. The center draper belt of claim 1 wherein the first and second ridges are no more than 1.5 cm high.

14. The center draper belt of claim 12 wherein the first and second ridges are no more than 4.0 cm high.

15. The center draper belt of claim 1 further comprising an array of third ridges fixed to a central portion of the crop-conveying surface of the web, wherein each of the third ridges extends generally longitudinally, defines a serpentine and has at least one recess opening laterally and disposed to receive and arrest plant stalks traveling laterally across the central portion in a first lateral direction.

16. The center draper belt of claim 15, wherein each ridge of the array of third ridges has at least one recess opening laterally and disposed to receive and arrest plant stalks traveling laterally across the central portion in a second lateral direction opposite the first lateral direction.

17. The center draper belt of claim 1, wherein the ratio of maximum crop mat thickness on the belt to maximum height of the first and second ridges is at least 5.

18. The center draper belt of claim 17, wherein the ratio of maximum crop mat thickness on the belt to maximum height of the first and second ridges is at least 10.

19. The center draper belt of claim 1 wherein the ratio of web width to travel path is preferably between 0.9 and 4.0.

20. A draper platform for an agricultural combine comprising an elongate frame, a reciprocating knife disposed along a leading edge of the frame, left and right conveyors disposed on the left and right sides of the frame, respectively and a center conveyor disposed on the frame between the left and right conveyors to receive a crop mat from the left and right conveyors and carry the combined crop mats from the left and right conveyors rearward toward the agricultural combine, the center conveyor comprising front and rear rollers and an endless center draper belt entrained about the front and rear rollers, wherein the center draper belt is in accordance with claim 1.
